(19) United States
(12) Patent Application Publication
(10) Pub. No.: US 2022/0207518 A1
(43) Pub. Date: Jun. 30, 2022

(54) CARD REGISTRATION SYSTEM, CARD REGISTRATION METHOD, AND INFORMATION STORAGE MEDIUM

(71) Applicant: Rakuten Group, Inc., Tokyo (JP)

(72) Inventor: Hideki AKASHIKA, Tokyo (JP)

(73) Assignee: Rakuten Group, Inc., Tokyo (JP)

(21) Appl. No.: 17/561,014

(22) Filed: Dec. 23, 2021

(30) Foreign Application Priority Data
Dec. 28, 2020 (JP) 2020-218792

(51) Int. Cl. G06Q 20/34; G06Q 20/32; G06Q 20/40

(52) U.S. Cl. CPC G06Q 20/354; G06Q 20/4014; G06Q 20/3255

(57) ABSTRACT

Provided is a card registration system including at least one processor configured to: acquire, when a registration request for a card is received from a user terminal, card information that enables identification of the card; acquire registered user information on a user who possesses the card, which has been registered in a server in advance in association with the card information; execute authentication based on the registered user information and input information input from the user terminal; and register the card based on an execution result of the authentication.

### CROSS-REFERENCE TO RELATED APPLICATION

The present application claims priority from Japanese application JP 2020-218792 filed on Dec. 28, 2020, the content of which is hereby incorporated by reference into this application.

### BACKGROUND OF THE INVENTION

### 1. Field of the Invention

The present disclosure relates to a card registration system, a card registration method, and an information storage medium.

### 2. Description of the Related Art

Hitherto, in order to prevent a malicious third party from committing a fraud, there has been known a technology for executing authentication. For example, in JP 2002-298054 A, there is described a technology for executing authentication by transmitting a short message service text message (hereinafter referred to simply as “SMS”) to a mobile phone of a user when the user is to use a card on the Internet. Meanwhile, for example, in JP 2018-036790 A, there is described a technology for making a call to a telephone number registered in association with an IC card or transmitting an SMS to the telephone number in order to confirm the identity of a user who is to use the IC card.

### SUMMARY OF THE INVENTION

The inventor(s) has (have) investigated executing authentication in order to prevent unauthorized registration of a card from being performed by a third party. However, with the technology of JP 2002-298054 A, a third party who has illegally obtained, for example, a card number is only required to operate his or her mobile phone to have an SMS transmitted to that mobile phone, and hence security cannot be improved. Meanwhile, for example, with the technology of JP 2018-036790 A, the identity of a user is confirmed when the user is to use an IC card, and is not assumed to be confirmed when a card is to be registered, and hence the security at a time of registration of a card cannot be improved.

One object of the present disclosure is to enhance the security at a time of registration of a card.

According to at least one embodiment of the present disclosure, there is provided a card registration system including at least one processor configured to: acquire, when a registration request for a card is received from a user terminal, card information that enables identification of the card; acquire registered user information on a user who possesses the card, which has been registered in a server in advance in association with the card information; execute authentication based on the registered user information and input information input from the user terminal; and register the card based on an execution result of the authentication.

### BRIEF DESCRIPTION OF THE DRAWINGS

FIG. 1 is a diagram for illustrating an example of an overall configuration of a card registration system.

FIG. 2 is a view for illustrating an example of a flow of registering a card in an app.

FIG. 3 is a view for illustrating an example of an execution result of authentication using an SMS.

FIG. 4 is a functional block diagram for illustrating an example of functions implemented by a card registration system according to a first embodiment of the present disclosure.

FIG. 5 is a table for showing a data storage example of a user database.

FIG. 6 is a table for showing a data storage example of a card database.

FIG. 7 is a flow chart for illustrating an example of processing to be executed in the first embodiment.

FIG. 8 is a flow chart for illustrating the example of the processing to be executed in the first embodiment.

FIG. 9 is a functional block diagram in a second embodiment of the present disclosure.

FIG. 10 is a flow chart for illustrating an example of processing to be executed in the second embodiment.

FIG. 11 is a flow chart for illustrating the example of the processing to be executed in the second embodiment.

FIG. 12 is a view for illustrating a flow of authentication in a third embodiment of the present disclosure.

FIG. 13 is a flow chart for illustrating an example of processing to be executed in the third embodiment.

FIG. 14 is a flow chart for illustrating the example of the processing to be executed in the third embodiment.

FIG. 15 is a functional block diagram in a fourth embodiment of the present disclosure.

FIG. 16 is a flow chart for illustrating an example of processing to be executed in the fourth embodiment.

FIG. 17 is a flow chart for illustrating the example of the processing to be executed in the fourth embodiment.

FIG. 18 is a functional block diagram in modification examples of the present disclosure.

### DETAILED DESCRIPTION OF THE INVENTION

### 1. First Embodiment

Now, an example of a card registration system according to a first embodiment of the present disclosure is described. In the first embodiment, authentication executed when a transportation-related IC card (hereinafter referred to simply as “card”) is to be registered is taken as an example. In the following description, like components are denoted by like reference symbols.

### 1-1. Overall Configuration of Card Registration System

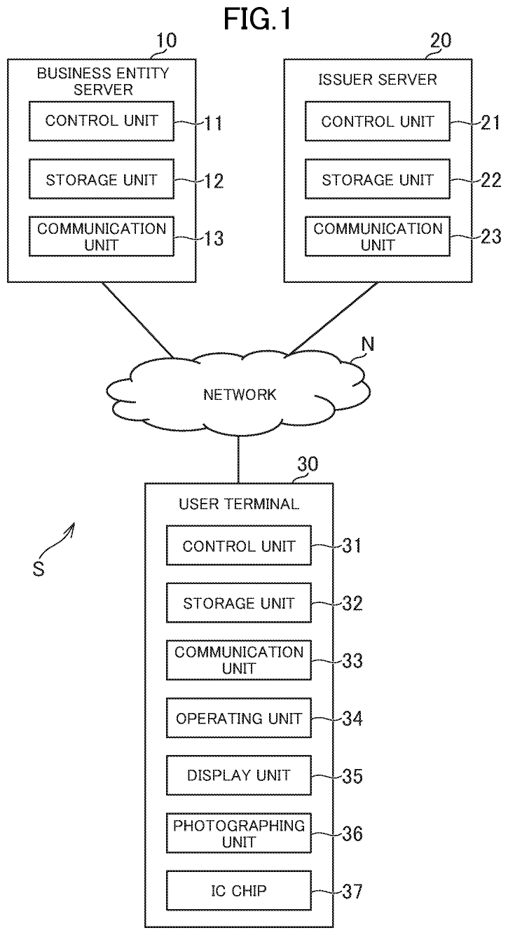

FIG. 1 is a diagram for illustrating an example of an overall configuration of the card registration system. As illustrated in FIG. 1, a card registration system S includes a business entity server 10, an issuer server 20, and a user terminal 30. Each of the business entity server 10, the issuer server 20, and the user terminal 30 can be connected to a network N, for example, the Internet. In FIG. 1, one business entity server 10, one issuer server 20, and one user terminal 30 are illustrated, but there may be a plurality of business entity servers 10, a plurality of issuer servers 20, and a plurality of user terminals 30.

The business entity server 10 is a server computer corresponding to a business entity that provides a service using a card. The business entity is an entity that provides a service to a user. In the first embodiment, a transportation-related service using a card is taken as an example, and hence the business entity is, for example, a railroad company or a bus company.

The business entity server 10 includes a control unit 11, a storage unit 12, and a communication unit 13. The control unit 11 includes at least one processor. The storage unit 12 includes a volatile memory, for example, a RAM, and a nonvolatile memory, for example, a hard disk drive. The communication unit 13 includes at least one of a communication interface for wired communication or a communication interface for wireless communication.

The issuer server 20 is a server computer corresponding to an issuer that has issued a card. The issuer is an entity that provides a card to a user. In the first embodiment, a case in which the issuer and the business entity are the same is described, but the issuer and the business entity may be different from each other. The issuer server 20 includes a control unit 21, a storage unit 22, and a communication unit 23. Physical configurations of the control unit 21, the storage unit 22, and the communication unit 23 may be the same as those of the control unit 11, the storage unit 12, and the communication unit 13, respectively.

The user terminal 30 is a computer to be operated by a user. For example, the user terminal 30 is a smartphone, a tablet computer, a wearable terminal, or a personal computer. The user terminal 30 includes a control unit 31, a storage unit 32, a communication unit 33, an operating unit 34, a display unit 35, a photographing unit 36, and an IC chip 37. Physical configurations of the control unit 31, the storage unit 32, and the communication unit 33 are the same as those of the control unit 11, the storage unit 12, and the communication unit 13, respectively.

The operating unit 34 is an input device, for example, a touch panel. The display unit 35 is a liquid crystal display or an organic EL display. The photographing unit 36 includes at least one camera. The IC chip 37 is a chip that supports NFC.

The IC chip 37 may be a chip of any standards, for example, a chip of FeliCa (trademark) or a chip of a so-called Type A or Type B among the non-contact type standards. The IC chip 37 includes hardware including an antenna conforming to the standards, and stores, for example, information required for a service to be used by a user.

At least one of programs or data stored in the storage units 12, 22, and 32 may be supplied thereto via the network N. Further, each of the business entity server 10, the issuer server 20, and the user terminal 30 may include at least one of a reading unit (e.g., an optical disc drive or a memory card slot) for reading a computer-readable information storage medium, or an input/output unit (e.g., a USB port) for inputting and outputting data to/from an external device. For example, at least one of the program or the data stored in the information storage medium may be supplied through intermediation of at least one of the reading unit or the input/output unit.

### 1-2. Outline of First Embodiment

In the first embodiment, processing of the card registration system S is described by taking as an exemplary case in which a user registers a card in a transportation-related application (hereinafter referred to simply as “app”). The app in the first embodiment is a program for using a transportation-related service through use of the user terminal 30. The app has been downloaded and installed in the user terminal 30 in advance.

The registering of a card in the app means enabling a service equivalent to a service available through use of the card to be used from the app. For example, enabling use of card information from the app, associating the card information with the app, or associating the card information with a user account corresponds to the registering of the card in the app. In addition, for example, recording the card information in the business entity server 10 or the IC chip 37 corresponds to the registering of the card in the app.

The card information is information that can identify the card. The card information includes at least a card number.

The card number is a number that uniquely identifies the card. The card information may include supplementary information that accompanies the card. The supplementary information is information other than the card number, for example, an expiration date of the card, a full name of the user, an issue date of the card, or an ID that can identify an IC chip included in the card. When a plurality of services can be used through use of the card, an ID used for each service also corresponds to the supplementary information. For example, the user finishes registering use of the app to have a user account and other information issued. After that, in order to register the card in the app, the user performs an operation for registering the card from, for example, a menu of the app. When this operation is performed, an input screen for inputting the card information of the card to be registered in the app is displayed on the display unit 35.

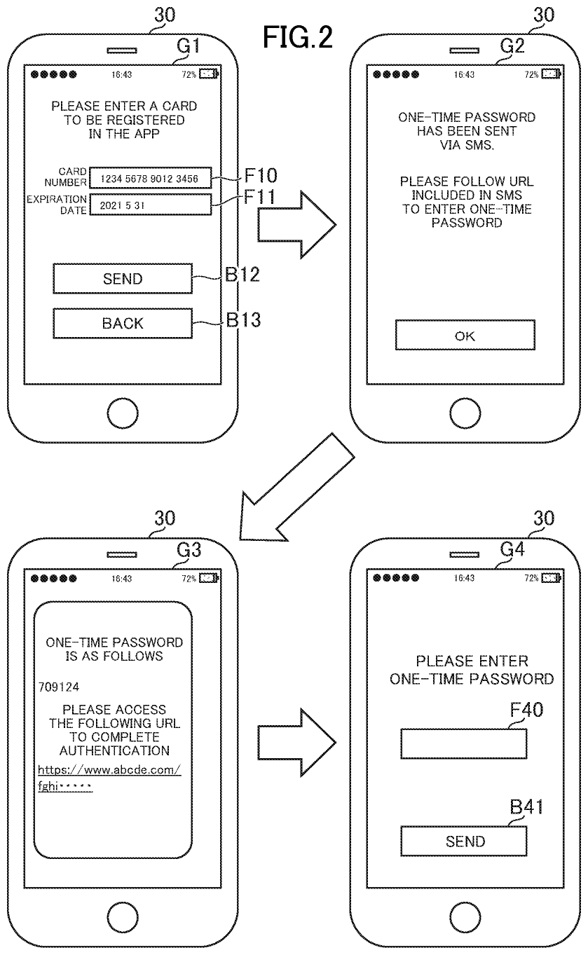

FIG. 2 is a view for illustrating an example of a flow of registering the card in the app. As illustrated in FIG. 2, on an input screen Gl, an input form F10 for inputting the card number and an input form Fll for inputting the expiration date are displayed. The user examines the card number and the expiration date of the card to be registered in the app, and inputs the card number and the expiration date to the input forms F10 and F11, respectively. The input screen G1 may be displayed as a part of a procedure for registering the use of the app.

The first embodiment is described by taking, as an example of authentication at a time of card registration, authentication using a telephone number registered in the issuer server 20. Authentication using an SMS for this telephone number is taken as an example, but authentication involving making a call to this telephone number may be executed. When the user selects a button B12 on the input screen Gl, an SMS including a one-time password is transmitted to the telephone number of the user, which has been registered in the issuer server 20. This telephone number is a telephone number registered in the issuer server 20 in association with the card number and the expiration date that have been input to the input forms F10 and F11.

When the user selects an SMS icon on the user terminal 30, the received SMS is displayed on an SMS screen G3. The SMS includes the one-time password and a URL of an authentication screen G4. When the user selects the URL in the SMS, the authentication screen G4 for inputting the one-time password is displayed on the display unit 35. The user inputs the one-time password in an input form F40. When the user selects a button B41, the user terminal 30 transmits the one-time password to the business entity server 10, and authentication is executed.

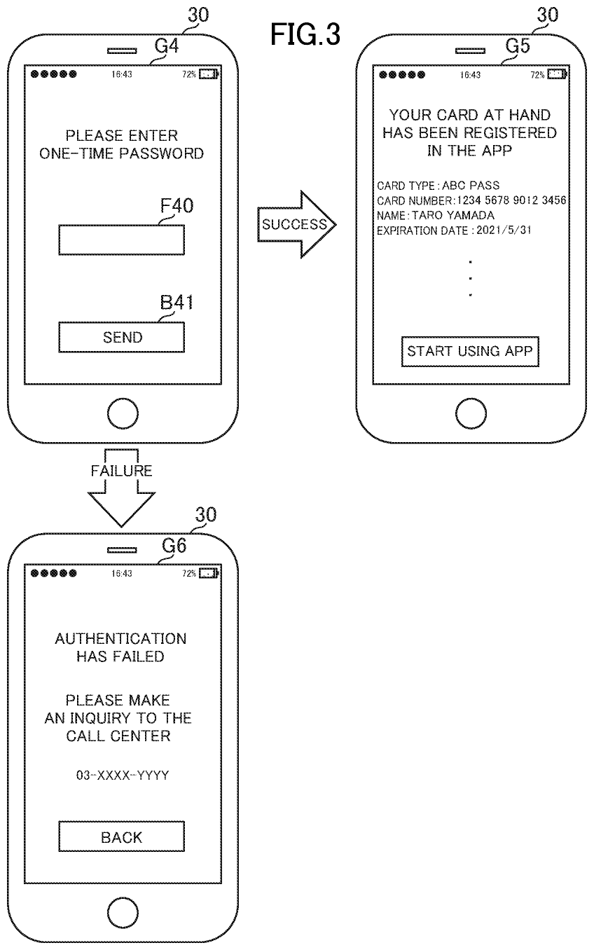

FIG. 3 is a view for illustrating an example of an execution result of authentication using an SMS. As illustrated in FIG. 3, when the one-time password input by the user is correct, the authentication is successful, and a success screen G5 indicating that the registration of the card in the app has been completed is displayed. After that, the user can use, from the app, the same service as that available when the physical card is used. Meanwhile, when the one-time password input by the user is not correct, the authentication fails, and a failure screen G6 indicating that the registration of the card in the app has not been completed is displayed. The user returns to the input screen G1 to input, for example, the card number again, and performs an inquiry to a call center.

As described above, when the user is to register the card in the app, the card registration system S according to the first embodiment transmits an SMS including a one-time password to the telephone number registered in advance in the issuer server 20. The card registration system S is configured to request the user to input the one-time password included in the SMS, to thereby enhance security at the time of the card registration. Now, details of this technology are described.

### 1-3. Functions implemented in First Embodiment

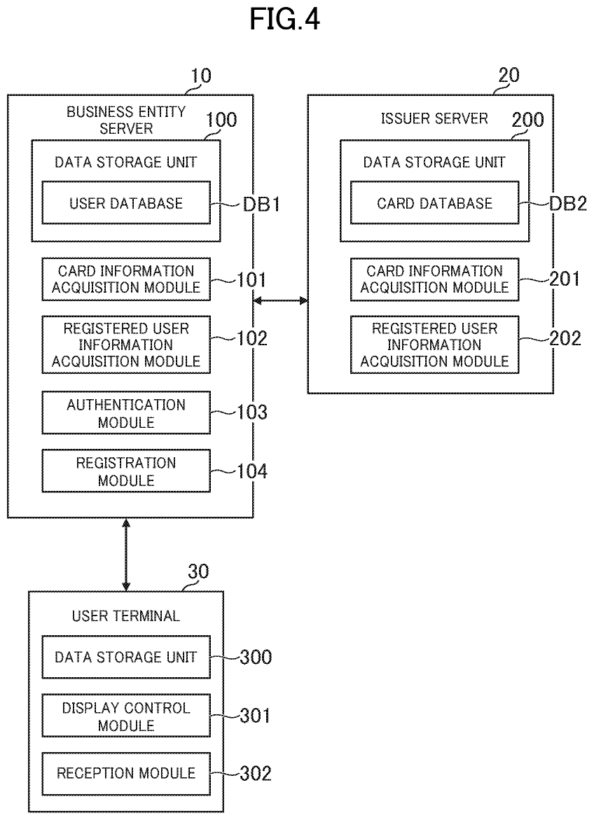

FIG. 4 is a functional block diagram for illustrating an example of functions implemented by the card registration system S according to the first embodiment. In this case, the functions implemented by each of the business entity server 10, the issuer server 20, and the user terminal 30 are described.

### 1-3-1. Functions implemented on Business Entity Server

As illustrated in FIG. 4, on the business entity server 10, a data storage unit 100, a card information acquisition module 101, a registered user information acquisition module 102, an authentication module 103, and a registration module 104 are implemented. The data storage unit 100 is implemented mainly by the storage unit 12. Each of the other functions is mainly implemented by the control unit 11.

### Data Storage Unit

The data storage unit 100 stores the data required for authentication. For example, a user database DB1 is described for the data storage unit 100.

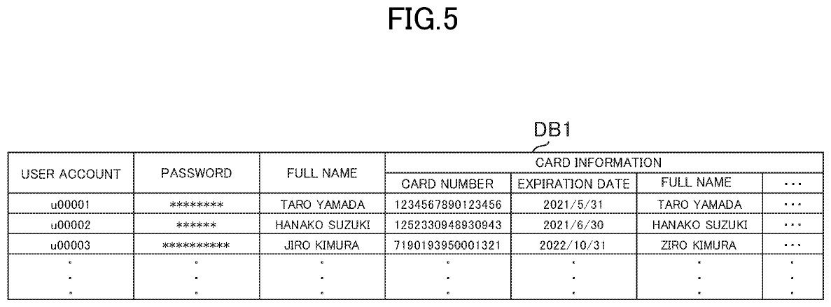

FIG. 5 is a table for showing a data storage example of the user database DB1. As shown in FIG. 5, the user database DB1 is a database in which information relating to users is stored. For example, the user database DB1 stores a user account, a password, a full name, and card information. When a user has registered the use of a service, a user account is issued, and a new record is created in the user database DB1. This record stores a password and a full name that have been designated at a time of registration.

In the first embodiment, a case in which the card information is registered after registration of the use of the service has been completed is described, but the card information may be registered at a time of the registration of the use of the service. The card information stored in the user database DB1 is card information of the card registered in the app. The number of cards that can be registered in the app is not limited to one, and a plurality of cards may be registered in the app.

The card information stored in the user database DB1 is only required to include minimum information for providing the service. That is, not all pieces of supplementary information of the card are required to be stored in the user database DB1. The card information stored in the user database DB1 may be only the card number, or may include information (for example, a security code or a password in so-called 3-D Secure) other than the information shown in FIG. 5. The details of the card information are shown as they are in FIG. 5, but the card information may be hashed.

### Card Information Acquisition Module

When a registration request for a card is received from the user terminal 30, the card information acquisition module 101 acquires the card number that can identify the card. The card number is an example of card information. Accordingly, the card number as used in the first embodiment can be read as “card information.” The card information is information that can identify the card. The card information may be any information that uniquely identifies the card, and is not limited to the card number. A combination of a plurality of pieces of information, for example, the card number, the expiration date, and the full name, may correspond to the card information. As another example of the card information, an ID number corresponding to the card on a one-to-one basis may correspond to the card information.

In the first embodiment, the user inputs the card number to the input form F10, and hence the registered user information acquisition module 102 acquires the card number input by the user. It suffices that the card number is acquired by a method defined in advance, and the user is not required to manually input the card number. For example, the card information acquisition module 101 may execute optical character recognition on a photographed image obtained by photographing the card by the photographing unit 36, to thereby acquire the card number formed (printed or embossed) on a front side of the card. In addition, for example, when the card number is recorded on the user terminal 30, the registered user information acquisition module 102 may acquire the card number stored in the user terminal 30.

In the first embodiment, the business entity server 10 directly communicates to/from the user terminal 30, and hence the card information acquisition module 101 directly acquires the card number from the user terminal 30. When there is a computer for mediating communication between the business entity server 10 and the user terminal 30, the card information acquisition module 101 may acquire the card number transferred by this computer. That is, the card information acquisition module 101 may indirectly acquire the card number from the user terminal 30.

### Registered User Information Acquisition Module

The registered user information acquisition module 102 acquires registered user information on the user who possesses the card, which has been registered in the issuer server 20 in advance in association with the card number. The registered user information is user information registered in association with the card number. The registered user information and the input information may be information of the same type that enables comparison therebetween, but the first embodiment is described by taking a case in which the registered user information and the input information are information of different types. In the first embodiment, the registered user information is a telephone number to be used for notifying a one-time password to be input by the user. The information to be compared to the input information is still the one-time password held on the business entity server 10 side.

In the first embodiment, the issuer server 20 manages the telephone number as the registered user information, and hence the registered user information acquisition module 102 acquires the telephone number as the registered user information from the issuer server 20. The registered user information may be registered in a server other than the issuer server 20. For example, the registered user information may be registered in the business entity server 10, or may be registered in another server computer.

### Authentication Module

The authentication module 103 executes the authentication based on the registered user information and the one-time password input from the user terminal 30. The one-time password input by the user is an example of the input information. Accordingly, the one-time password input by the user as used in the first embodiment can be read as “input information.” The input information is information input from the user terminal 30. The input in the first embodiment means transmitting data.

The input information corresponds to a query at the time of the authentication. The input information is not limited to the one-time password, and may be any authentication information to be used for authentication. For example, the authentication information may be a password that can be used not only once but also a plurality of times. In addition, authentication information other than the password, for example, a passcode, may be used. The authentication information being a correct answer at the time of the authentication (authentication information corresponding to an index) may be any information having the same format as that of the input information (information that can be compared to the input information). The input information may be information manually input by the user, or may be information stored in the user terminal 30.

The authentication module 103 executes the authentication based on the registered user information and the one-time password input from the user terminal 30, but as described above, those are not compared to each other in the first embodiment. The registered user information is used solely to identify the user to be notified of the one-time password. The authentication module 103 executes the authentication based on the one-time password notified through use of the registered user information and the one-time password input from the user terminal 30.

For example, the authentication module 103 notifies the user of the one-time password by performing message transmission or telephone calling to the telephone number. The SMS is an example of this message. As the message itself to be sent to the telephone number, various messages can be used, and a message called by another name may be used. The telephone calling is mechanically executed by automatic voice (so-called interactive voice response or IVR). As the automatic telephone calling itself, various technologies can be used, and it suffices to make a voice call with the one-time password inserted into an automatic voice determined in advance.

As a method itself of generating a one-time password, it is possible to use various methods, and it is possible to use, for example, a method using a mathematical algorithm, a time synchronization type method, a challenge type method, or a method using a random number. The one-time password notified to the user is the correct answer at the time of the authentication, and is thus held in the data storage unit 100. In the data storage unit 100, the one-time password is associated with information, for example, the user account or the telephone number so that it can be identified which user has been notified of the one-time password.

The authentication module 103 executes the authentication based on the one-time password notified to the user and the one-time password input as the input information from the user terminal 30. The authentication module 103 acquires the one-time password input to the input form F40 of the authentication screen G4, and determines whether or not the one-time password matches the notified one-time password held in the data storage unit 100. When the one-time passwords match, the authentication is successful. When the one-time passwords do not match, the authentication fails. The authentication may be successful based on a partial match instead of a perfect match.

### Registration Module

The registration module 104 registers the card based on the execution result of the authentication performed by the authentication module 103. Registering the card means enabling the use of the card to be registered. In the first embodiment, registering the card in the app corresponds to registering the card. When the app is not used in particular, recording the card information on some computer, for example, the business entity server 10 may correspond to registering the card. The card to be registered is a card to be registered by the registration module 104. In the first embodiment, the card to be registered is a card having the card number input to the input form F10 by the user.

The registration module 104 registers the card when the authentication is successful, and does not register the card when the authentication fails. That is, the success or failure of the authentication is a condition for whether or not the registration module 104 registers the card. When the authentication of a certain user is successful, the registration module 104 registers the card by storing the card information of the card to be registered into a record of the user database DB1 that corresponds to the user account of the certain user. The user account is input at a time of login. The card information of the card to be registered is acquired from the issuer server 20.

### 1-3-2. Functions implemented on Issuer Server

As illustrated in FIG. 4, on the issuer server 20, a data storage unit 200, a card information acquisition module 201, and a registered user information acquisition module 202 are implemented. The data storage unit 200 is implemented mainly by the storage unit 22. Each of the other functions is mainly implemented by the control unit 21.

### Data Storage Unit

The data storage unit 200 stores the data required for authentication. For example, a card database DB2 is described for the data storage unit 200.

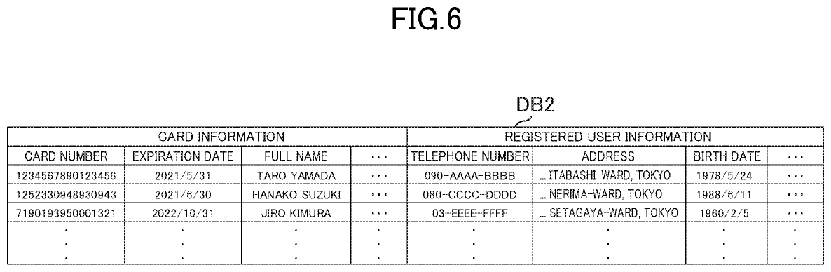

FIG. 6 is a table for showing a data storage example of the card database DB2. As shown in FIG. 6, the card database DB2 is a database in which card information of the issued card is stored. For example, the card database DB2 stores a card number, an expiration date, a full name, and registered user information. When a new card is issued, a new record is created in the card database DB2, and the card information of the new card is stored.

The card information stored in the card database DB2 may be only the card number, or may include information (for example, a security code or a password in so-called 3-D Secure) other than the information shown in FIG. 6. When the card is registered in the app, all or part of the card information of the card stored in the card database DB2 is stored into the user database DB1. The registered user information is registered by the issuer when the card is issued. For example, information including the telephone number, the address, and the birth date that have been input by the user at a time of issuance of the card is stored as the registered user information. The registered user information may be any information that relates to the user, and may be other such personal information as described in a third embodiment of the present disclosure.

### Card Information Acquisition Module

The card information acquisition module 201 acquires the card number of the card to be registered. In the first embodiment, the card information acquisition module 201 acquires the card number transferred from the business entity server 10. That is, the card information acquisition module 201 indirectly acquires the card number input from the user terminal 30. The card number may be directly input from the user terminal 30 to the issuer server 20. In this case, the card information acquisition module 201 directly acquires the card number input from the user terminal 30.

### Registered User Information Acquisition Module

The registered user information acquisition module 202 acquires the registered user information registered in association with the card number acquired by the card information acquisition module 201. In the first embodiment, the registered user information is stored in the card database DB2, and hence the registered user information acquisition module 202 acquires the registered user information from the card database DB2. The registered user information acquisition module 202 acquires the registered user information stored in the same record as that storing the card number acquired by the card information acquisition module 201. When the registered user information is stored in an external computer or an external information storage medium, the registered user information acquisition module 202 may acquire the registered user information from the external computer or the external information storage medium.

### 1-3-3. Functions implemented on User Terminal

As illustrated in FIG. 4, on the user terminal 30, a data storage unit 300, a display control module 301, and a reception module 302 are implemented. The data storage unit 300 is implemented mainly by the storage unit 32. Each of the display control module 301 and the reception module 302 is implemented mainly by the control unit 31. The data storage unit 300 stores data required for processing described in the first embodiment. For example, the data storage unit 300 stores a transportation-related app. The display control module 301 causes the display unit 35 to display each of the screens described with reference to FIG. 2 and FIG. 3 based on the app. The reception module 302 receives the user's operation on each screen.

### 1-4. Processing to be executed in First Embodiment

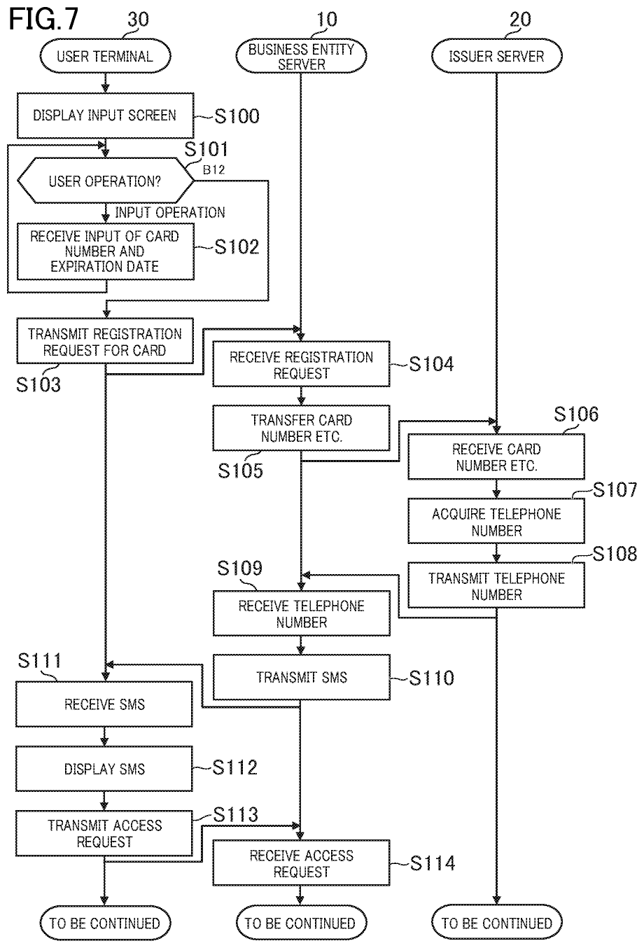

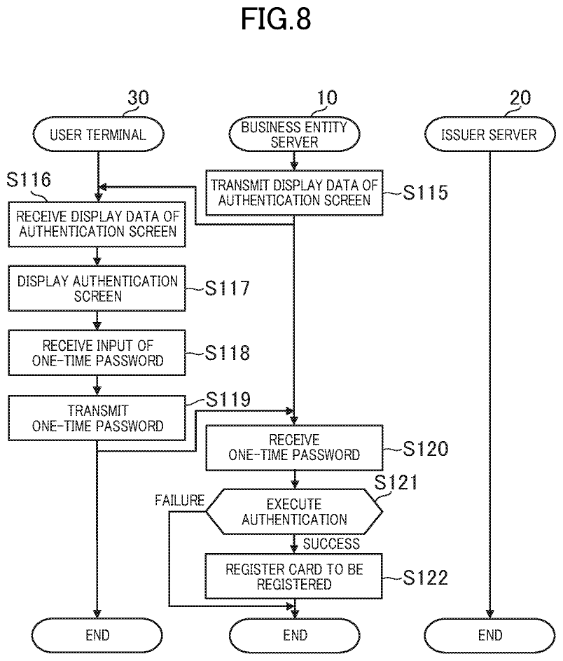

FIG. 7 and FIG. 8 are flow charts for illustrating an example of processing to be executed in the first embodiment. The processing illustrated in FIG. 7 and FIG. 8 is executed by the control units 11, 21, and 31 operating in accordance with the programs stored in the storage units 12, 22, and 32, respectively. This processing is an example of processing to be executed by the functional blocks illustrated in FIG. 4. This processing is executed when the app of the user terminal 30 is activated and an operation for registering the card is performed from a predetermined menu.

As illustrated in FIG. 7, the user terminal 30 causes the display unit 35 to display the input screen G1 for inputting a card number and an expiration date (Step S100). The user terminal 30 identifies an operation of the user based on a detection signal obtained by the operating unit 34 (Step S101). In Step S101, an input operation with respect to the input forms F10 and F11 or a selection operation for the button B12 is performed. When a selection operation for a button B13 is performed, this process ends.

When an input operation is performed on the input forms F10 and F11 (“input operation” in Step S101), the user terminal 30 receives the input of the card number and the expiration date of the card to be registered (Step S102), and the process returns to Step 5101. In Step 5102, the card number and the expiration date that have been input by the user are displayed on the input forms F10 and F11.

When the selection operation for the button B12 is performed (“B12” in Step S101), the user terminal 30 transmits a registration request for the card to the business entity server (Step S103). The registration request is performed by transmitting data having a predetermined format. The registration request includes the card number and the expiration date that have been input to the input forms F10 and F11, respectively. The user has already logged in to the app, and the user account of the user is also transmitted to the business entity server 10.

When the business entity server 10 receives the registration request from the user terminal 30 (Step S104), the business entity server 10 transfers the card number and the expiration date that are included in the registration request to the issuer server 20 (Step S105). When the issuer server 20 receives the card number and the expiration date from the business entity server 10 (Step S106), the issuer server 20 refers to the card database DB2 to acquire the telephone number associated with the card number and the expiration date that have been received (Step S107). In Step 5107, when a record matching a pair of the card number and the expiration date is not present in the card database DB2, an error occurs, and this process ends. In this case, at least one of the card number or the expiration date is incomplete, and hence the registration processing is not executed.

The issuer server 20 transmits the telephone number acquired in Step S107 to the business entity server 10 (Step S108). When the business entity server 10 receives the telephone number (Step S109), the business entity server 10 generates a one-time password, and transmits an SMS including the one-time password and the URL of the authentication screen G4 to the telephone number (Step S110). The telephone number and the one-time password are stored in the storage unit 12 in association with each other. When the user terminal 30 receives the SMS (Step S111), the user terminal 30 displays the received SMS on the SMS screen G3 (Step S112).

When the user selects the URL in the SMS, the user terminal 30 transmits an access request to the business entity server 10 (Step S113). When the business entity server 10 receives the access request (Step S114), the process advances to FIG. 8, and the business entity server 10 transmits display data of the authentication screen G4 to the business entity server 10 (Step S115). The display data may have any data format, for example, HTML. When the user terminal 30 receives the display data of the authentication screen G4 (Step S116), the user terminal 30 displays the authentication screen G4 on the display unit 35 (Step S117).

When the user terminal 30 receives the input of the one-time password to the input form F40 (Step S118), the user terminal 30 transmits, to the business entity server 10, the one-time password input by the user (Step S119). When the business entity server 10 receives the one-time password input by the user (Step S120), the business entity server 10 executes the authentication by comparing the received one-time password with the one-time password generated in Step 5110 to each other (Step S121).

When the one-time passwords match and the authentication is successful (“success” in Step S121), the business entity server 10 registers the card to be registered (Step S122), and this process ends. In Step S122, the business entity server 10 registers the card information of the card to be registered in the user database DB1 in association with the user account of the user. The business entity server 10 transmits the display data of the success screen G5 to the user terminal 30, and the success screen G5 is displayed.

Meanwhile, when the one-time passwords do not match and the authentication fails (“failure” in Step S121), the processing step of Step 5122 is not executed, and this process ends. In this case, the card information of the card to be registered is not registered in the user database DB1. The business entity server 10 transmits the display data of the failure screen G6 to the user terminal 30, and the failure screen G6 is displayed.

According to the card registration system S of the first embodiment, the one-time password is notified by transmitting an SMS to the registered telephone number associated with the card number of the card to be registered, and the authentication is executed based on the one-time password notified through use of the SMS and the one-time password input from the user terminal 30, to thereby enhance the security at the time of the card registration. This point is the same when the authentication is executed through use of the registered user information other than the telephone number, and the security at the time of the card registration is enhanced. In addition, the telephone number to which the SMS is to be transmitted is only registered in the issuer server 20, and hence even when a malicious third party attempts unauthorized registration of the card number, the SMS is only transmitted to a valid user. This inhibits the third party from registering the card number in the app. In addition, the SMS reaches a valid owner of the card, and hence it becomes easier to notice a fraud by the third party.

Further, in the card registration system S, the issuer server 20 manages the registered user information, to thereby eliminate requirement for management of the registered user information on the business entity server 10 and prevent the registered user information from being transmitted frequently on the network N. Accordingly, the registered user information being confidential information is less liable to be leaked, to thereby be able to effectively enhance the security. In addition, the processing required for the authentication is shared between the business entity server 10 and the issuer server 20, to thereby be able to distribute processing loads at the time of the authentication.

### 2. Second Embodiment

Next, the card registration system S according to a second embodiment of the present disclosure is described. The second embodiment is described by taking a case in which each of the business entity server 10 and the issuer server 20 manages the telephone number. The business entity server 10 registers the telephone number input by the user at the time of the registration of the use of the app. The issuer server 20 registers the telephone number input by the user at the time of the issuance of the card. Accordingly, when different telephone numbers are input even by the same user, the telephone number managed by the business entity server 10 and the telephone number managed by the issuer server 20 are different. That is, the telephone number managed by the business entity server 10 and the telephone number managed by the issuer server 20 are inconsistent. The same points as those of the first embodiment are omitted from the following description.

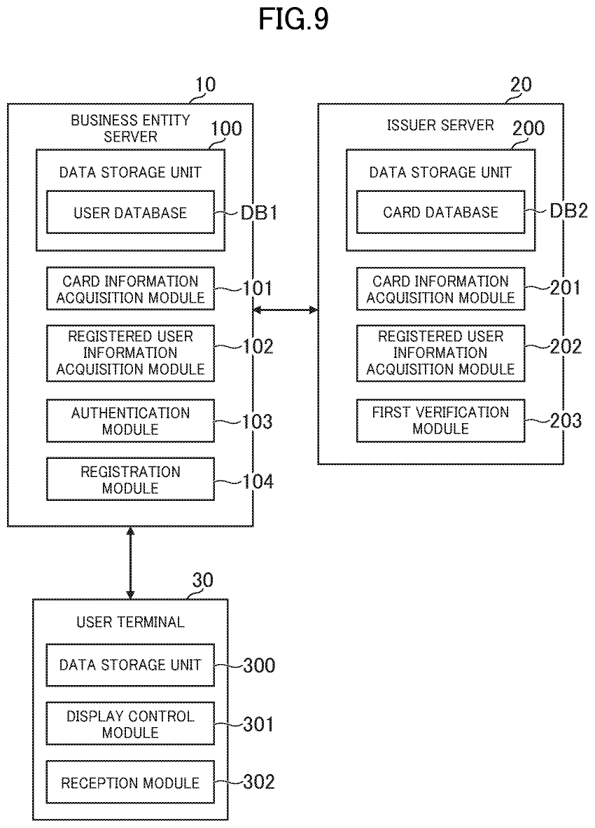

FIG. 9 is a functional block diagram in the second embodiment. In the user database DB1 in the second embodiment, a telephone number is stored in association with a user account. This telephone number is a telephone number input by the user at the time of the registration of the use of the service. The user can change the telephone number stored in the user database DB1 after the registration of the use.

As illustrated in FIG. 9, the issuer server 20 in the second embodiment includes a first verification module 203. The first verification module 203 is implemented mainly by the control unit 21. The first verification module 203 determines whether or not the telephone number managed by the business entity server 10 and the telephone number managed by the issuer server 20 match. For example, the business entity server 10 refers to the user database DB1 to acquire the telephone number associated with the user account of the user who has transmitted the registration request for the card. The business entity server 10 transmits to the issuer server 20 the acquired telephone number and the card number of the card to be registered.

The first verification module 203 refers to the card database DB2 to acquire the telephone number associated with the card number received from the issuer server 20. The first verification module 203 determines whether or not the telephone number received from the business entity server 10 and the telephone number acquired from the card database DB2 match, and transmits a result of the determination to the business entity server 10.

When the first verification module 203 determines that the telephone numbers match, the authentication module 103 performs the message transmission or the telephone calling. In the second embodiment, the issuer server 20 includes the first verification module 203, and hence the authentication module 103 acquires, from the issuer server 20, the determination result obtained by the first verification module 203. When the first verification module 203 does not determine that the telephone numbers match, the authentication module 103 does not perform the message transmission or the telephone calling. A function equivalent to that of the first verification module 203 may be included in the authentication module 103, and the authentication module 103 may determine whether or not the telephone numbers match.

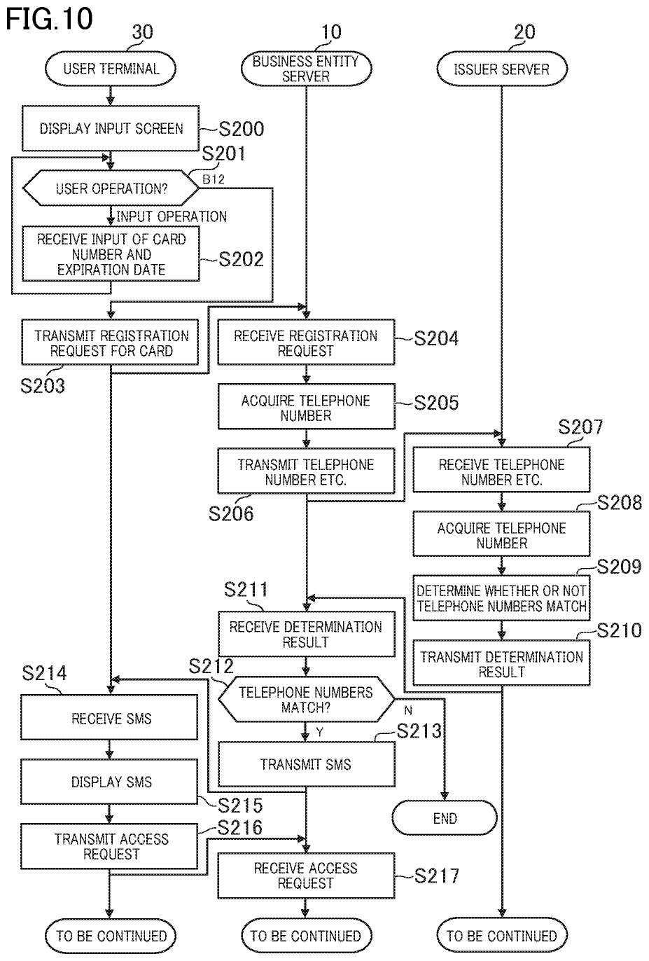

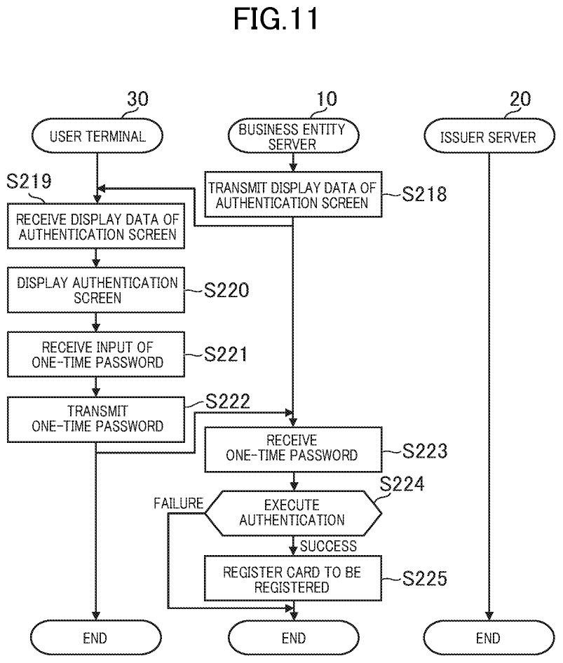

FIG. 10 and FIG. 11 are flow charts for illustrating an example of processing to be executed in the second embodiment. As illustrated in FIG. 10, the processing steps of from Step S200 to Step 5204 are the same as the processing steps of from Step S100 to Step S104. The business entity server 10 refers to the user database DB1 to acquire the telephone number associated with the user account of the user who has made the registration request (Step S205), and transmits, to the issuer server 20, the card number and the expiration date that are included in the registration request and the acquired telephone number (Step S206). The subsequent processing steps of Step S207 and Step S208 are the same as the processing steps of Step S107 and Step S108.

The issuer server 20 determines whether or not the telephone number received from the business entity server 10 and the telephone number acquired in Step S208 match (Step S209). The issuer server 20 transmits the determination result obtained in Step S209 to the business entity server 10 (Step S210). When the business entity server 10 receives the telephone number and the determination result (Step S211), the business entity server 10 determines whether or not the determination result indicates that the telephone numbers match (Step S212). When the determination result indicates that the telephone numbers match (Y in Step S212), the subsequent processing steps of from Step S213 to Step S225 are the same as the processing steps of from Step S110 to Step S122. When the determination result does not indicate that the telephone numbers match (N in Step S211), this process ends. In this case, the SMS is not transmitted, and the authentication itself is not executed. Accordingly, the card is not registered as well.

According to the second embodiment, it is determined whether or not the telephone number managed by the business entity server 10 and the telephone number managed by the issuer server 20 match, and when it is determined that those telephone numbers match, the one-time password is notified through use of the SMS or the telephone to execute the authentication. When a fraud is suspected, for example, when the two telephone numbers do not match, the one-time password notification itself using the SMS or the telephone is not executed, to thereby be able to reliably prevent unauthorized registration of the card and effectively enhance the security. For example, even when a malicious third party registers the use of the app, the SMS authentication cannot be successful unless the telephone number of a valid user has been registered in the business entity server 10, and hence the security is enhanced.

Further, the issuer server 20 executes comparison between the telephone numbers, and the business entity server 10 acquires the comparison result from the issuer server 20 to execute the authentication, to thereby eliminate requirement for management of the telephone number on the business entity server 10 and prevent the telephone number from being transmitted on the network N. Accordingly, the telephone number being confidential information is less liable to be leaked, to thereby be able to effectively enhance the security. In addition, the processing required for the authentication is shared between the business entity server 10 and the issuer server 20, to thereby be able to distribute processing loads at the time of the authentication.

### 3. Third Embodiment

Next, the card registration system S according to the third embodiment is described. In the first embodiment and the second embodiment, the authentication using the SMS transmission or the telephone calling to the telephone number has been described, but in the third embodiment, another authentication method using personal information is described. The same points as those of the first embodiment and the second embodiment are omitted from the description.

The registered user information in the third embodiment is personal information. The personal information is information relating to an individual user. The personal information is information that can identify an individual. The personal information is not required to uniquely identify the user. An address of a home at which a plurality of family members live or other information that can identify the user in some way, instead of identifying one user separately from the other family members, may correspond to the personal information.

The telephone number described in each of the first embodiment and the second embodiment is also one example of the personal information. In addition, for example, the personal information may be a name, an age, a birth date, a gender, an address, an email address, a messaging app account, a social media account, a workplace, a school name, a bank account, or a combination thereof. In the third embodiment, the personal information being the registered user information is used not for notifying the authentication information but for prompting the user to input the personal information. That is, the authentication is executed by prompting the user to input all or a part of the personal information registered as the registered user information.

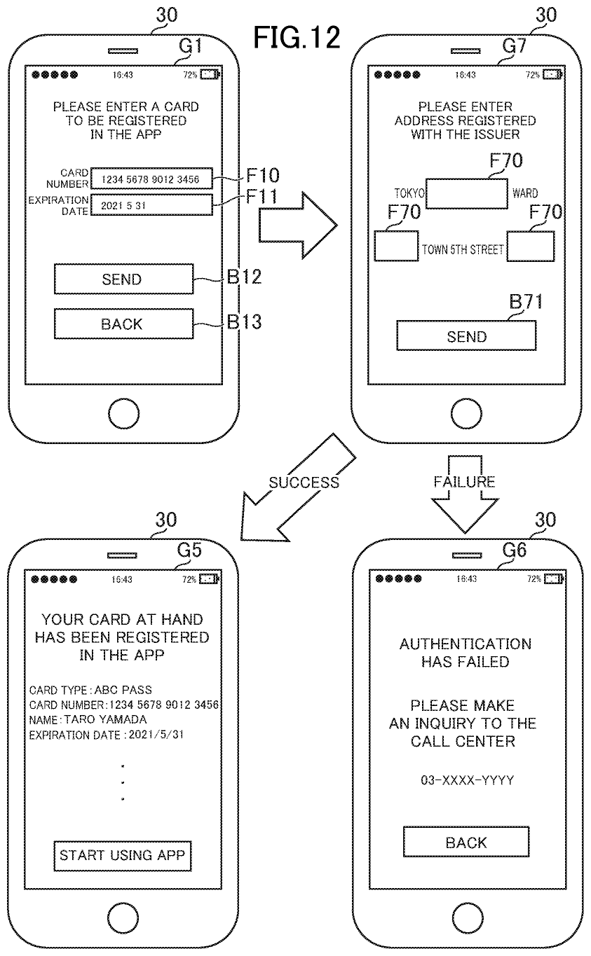

FIG. 12 is a view for illustrating a flow of authentication in the third embodiment. As illustrated in FIG. 12, when the user inputs the card number and the expiration date in the input forms F10 and F11 of the input screen G1 and selects the button B12, an authentication screen G7 for prompting the user to input a part of the personal information registered in the issuer server 20 is displayed on the display unit 35. In the third embodiment, the address is described as the personal information prompted to be input by the user. On the authentication screen G7, the input of a part of the address of the user, which has been registered in the issuer server 20 in association with the card to be registered, is prompted.

When the user inputs a part of the address from an input form F70 and selects a button B71, the user terminal 30 transmits, to the business entity server 10, the part of the address input by the user. When the part of the address input by the user matches the part of the address registered in the issuer server 20, the success screen G5 is displayed, and when the part of the address input by the user does not match the part of the registered address, the failure screen G6 is displayed.

A functional block diagram in the third embodiment is the same as that in the first embodiment. The registered user information acquisition module 102 of the business entity server 10 acquires the personal information from the issuer server 20 as the registered user information. The business entity server 10 transmits the card number and the expiration date that are included in the registration request to the issuer server 20. When the issuer server 20 receives the card number and the expiration date, the issuer server 20 refers to the card database DB2 to acquire the personal information associated therewith. The issuer server 20 transmits the acquired personal information to the business entity server 10. The registered user information acquisition module 102 acquires the transmitted personal information.

The authentication module 103 of the business entity server 10 executes the authentication based on all or a part of the personal information registered as the registered user information and all or a part of the personal information input from the user terminal 30 as the input information. When the user is to be prompted to input a part of personal information, the user is notified of which part is to be input. The authentication module 103 determines whether or not the registered personal information and the input personal information match. When those pieces of information match, the authentication is successful. When those pieces of information do not match, the authentication fails.

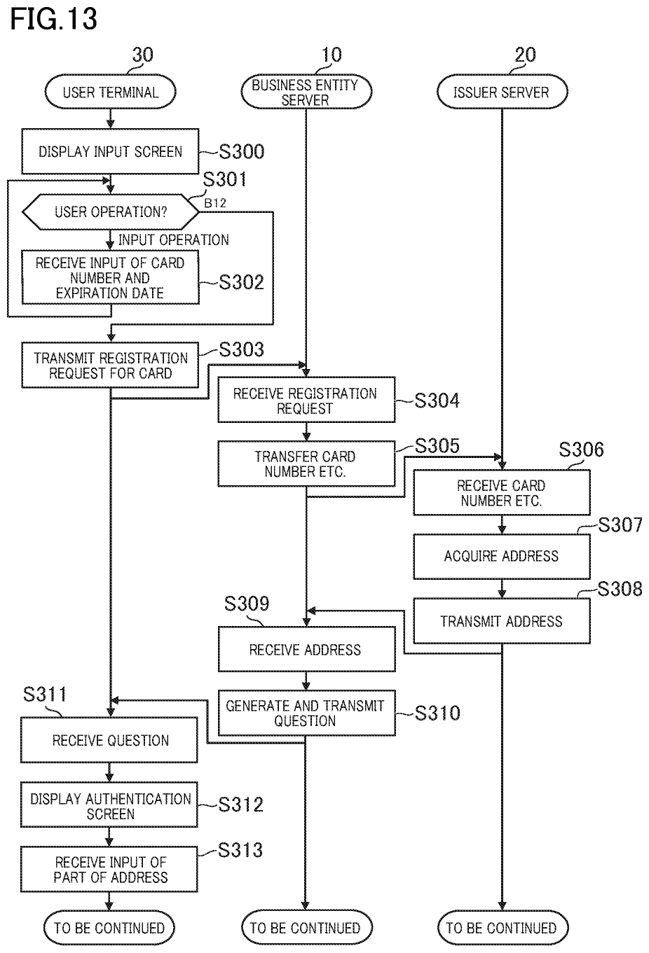

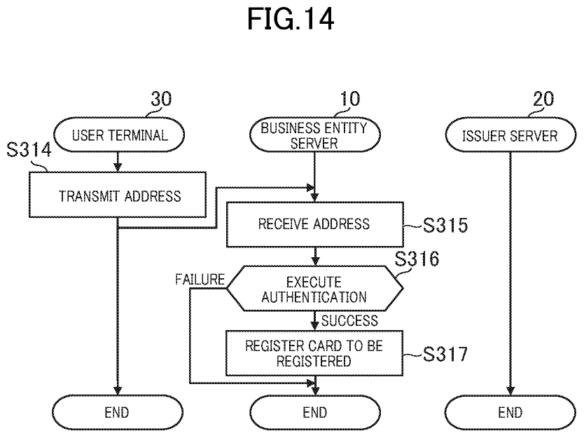

FIG. 13 and FIG. 14 are flow charts for illustrating an example of processing to be executed in the third embodiment. As illustrated in FIG. 13, the processing steps of from Step S300 to Step 5306 is the same as the processing steps of from Step 5100 to Step 5106. The issuer server 20 refers to the card database DB2 to acquire, as the registered user information, the address associated with the card number and the expiration date that have been received (Step S307). In Step 5307, when a record matching a pair of the card number and the expiration date is not present in the card database DB2, an error occurs, and this process ends. In this case, at least one of the card number or the expiration date is incomplete, and hence the registration processing is not executed.

The issuer server 20 transmits the address acquired in Step S307 to the business entity server 10 (Step S308). When the business entity server 10 receives the address (Step S309), the business entity server 10 generates a question for the authentication screen G7, and transmits the question to the user terminal 30 (Step S310). In the third embodiment, it is assumed that a portion of the address prompted to be input by the user is defined in advance. In addition, the address serving as the correct answer is stored in the storage unit 12. The user terminal 30 receives the question (Step S311) and displays the authentication screen G7 on the display unit 35 (Step S312).

When the user terminal 30 receives the input of a part of the address to the input form F40 (Step S313), the process advances to FIG. 14, and the user terminal 30 transmits, to the business entity server 10, the part of the address input by the user (Step S314). When the business entity server 10 receives the part of the address input by the user from the user terminal (Step S315), the business entity server 10 executes the authentication by determining whether or not the part of the address input by the user and the address serving as the correct answer match (Step S316). The subsequent processing step of Step S317 is the same as the processing step of Step S122.

According to the third embodiment, the authentication is executed based on all or a part of the personal information input by the user and all or a part of the personal information registered in the issuer server 20, to thereby enhance the security at the time of the card registration. This point is the same when the authentication is executed through use of personal information other than the address, and the security at the time of the card registration is enhanced. For example, even when the user is to be prompted to input all or only a part of the email address or the telephone number, the authentication cannot be successful as long as the information is unknown to a fraudulent third party, and hence the security is enhanced. When a part of the personal information is to be input, the other part of the personal information is not required to be displayed. Further, in the card registration system S, the issuer server 20 manages the registered user information, to thereby eliminate requirement for management of the registered user information on the business entity server 10 and prevent the registered user information from being transmitted frequently on the network N. Accordingly, the registered user information being confidential information is less liable to be leaked, to thereby be able to effectively enhance the security. In addition, the processing required for the authentication is shared between the business entity server 10 and the issuer server 20, to thereby be able to distribute processing loads at the time of the authentication.

### 4. Fourth Embodiment

Next, the card registration system S according to a fourth embodiment of the present disclosure is described. The fourth embodiment is described by taking a case in which processing for determining whether or not all or a part of the personal information registered in the issuer server 20 and all or a part of the personal information input from the user terminal 30 match is executed by the issuer server 20. The same points as those of the first embodiment to the third embodiment are omitted from the following description.

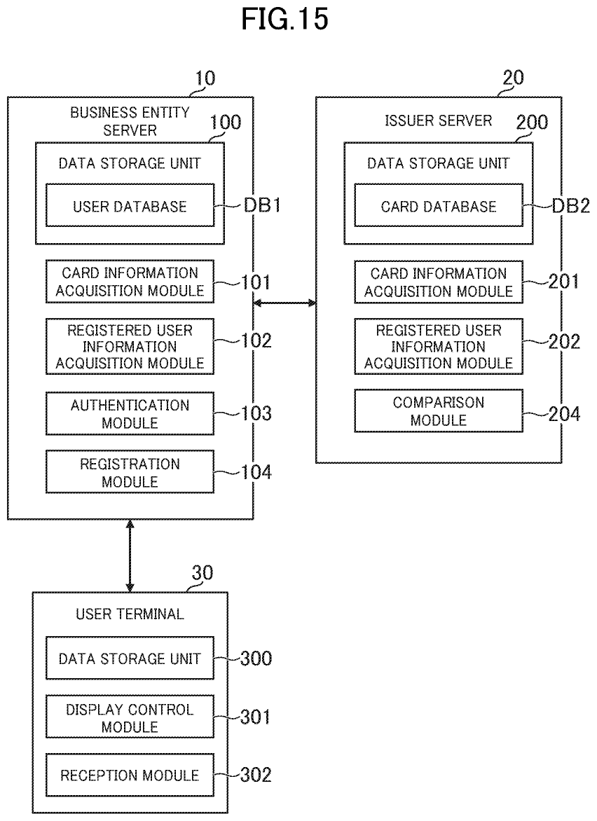

FIG. 15 is a functional block diagram in the fourth embodiment. As illustrated in FIG. 15, in the fourth embodiment, the issuer server 20 includes a comparison module 204. The comparison module 204 is implemented mainly by the control unit 21. The comparison module 204 compares all or a part of the personal information input from the user terminal 30 as input information and all or a part of the personal information registered as registered user information to each other. This comparison has the same meaning as determining whether or not those match.

In the same manner as in the third embodiment, the case in which the user inputs the part of the address is taken as an example, and the business entity server 10 transfers, to the issuer server 20, a part of the address input by the user. The comparison module 204 receives the part of the address transferred from the business entity server 10, and compares the received part of the address to the one registered in the issuer server 20. The issuer server 20 transmits a determination result of whether or not those parts match to the business entity server 10 as a comparison result.

The authentication module 103 acquires the comparison result obtained by the comparison module 204 from the issuer server 20, and executes the authentication. When the all or a part of the personal information that has been input and the all or a part of the personal information that has been registered match, the authentication is successful. When the all or a part of the personal information that has been input and the all or a part of the personal information that has been registered do not match, the authentication fails.

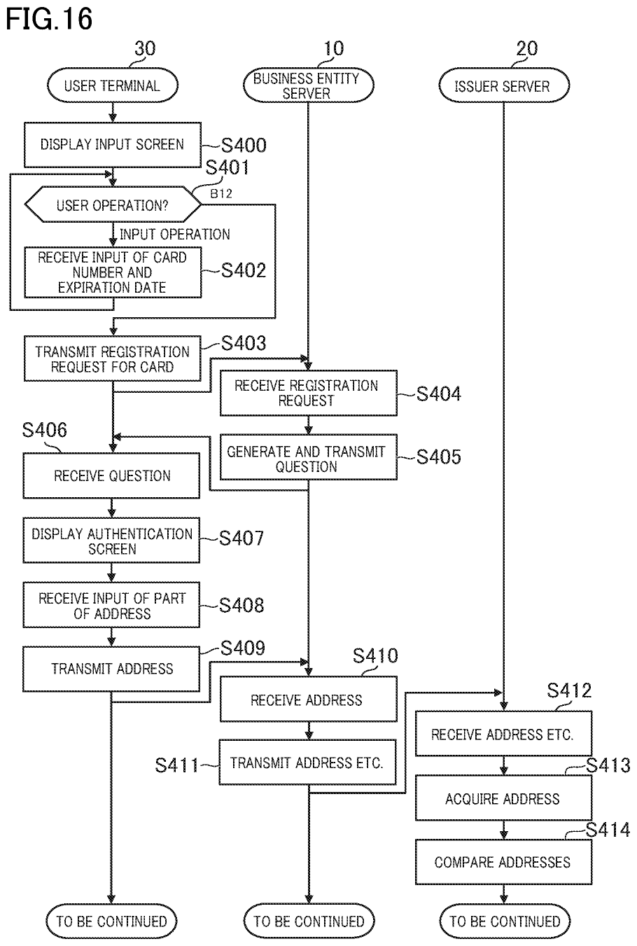

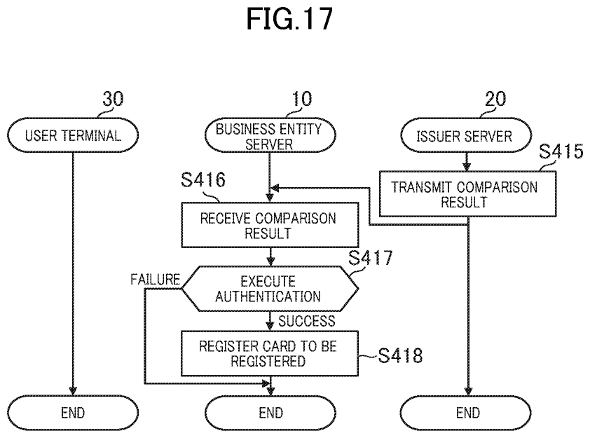

FIG. 16 and FIG. 17 are flow charts for illustrating an example of processing to be executed in the fourth embodiment. As illustrated in FIG. 16, the processing steps of from Step S400 to Step S404 is the same as the processing steps of from Step S100 to Step S104. When the business entity server 10 receives the registration request, the business entity server 10 generates a question relating to the input of the personal information, and transmits the question to the user terminal 30 (Step S405). At the time point of Step S405, the address registered in the issuer server 20 has not been acquired, and hence it is not required to display such hint portions as shown on the authentication screen G7 of FIG. 12. For example, the user may be prompted to input the entire address, or may be prompted to input only a predetermined portion, for example, a ward or a street address.

The subsequent processing steps of from Step S406 to Step S410 are the same as the processing steps of from Step S311 to Step S315. The business entity server 10 transmits, to the issuer server 20, the card number and the expiration date that are included in the registration request and the part of the address input by the user (Step S411). The issuer server 20 receives the card number, the expiration date, and the part of the address (Step S412), and refers to the card database DB2 to acquire, as registered user information, the address associated with the card number and the expiration date that have been received (Step S413).

The issuer server 20 compares the part of the address acquired as the registered user information in Step S413 to the part of the address input by the user and then received in Step S412 (Step S414). The process advances to FIG. 17, and the issuer server 20 transmits the comparison result to the business entity server 10 (Step S415). The business entity server 10 receives the comparison result (Step S416), and refers to the comparison result to execute the authentication (Step S417). The subsequent processing step of Step S418 is the same as the processing step of Step S122.

According to the fourth embodiment, the authentication is executed based on all or a part of the personal information input by the user and all or a part of the personal information registered in the issuer server 20, to thereby enhance the security at the time of the card registration. This point is the same when the authentication is executed through use of personal information other than the address, and the security at the time of the card registration is enhanced. Further, the issuer server 20 executes comparison between the addresses, and the business entity server 10 acquires the comparison result from the issuer server 20 to execute the authentication, to thereby eliminate requirement for management of the address on the business entity server 10 and prevent the address from being transmitted on the network N. Accordingly, the address being confidential information is less liable to be leaked, to thereby be able to effectively enhance the security. In addition, the processing required for the authentication is shared between the business entity server 10 and the issuer server 20, to thereby be able to distribute processing loads at the time of the authentication.

### 5. Modification Examples

The present disclosure is not limited to the embodiments described above, and can be modified suitably without departing from the spirit of the present disclosure.

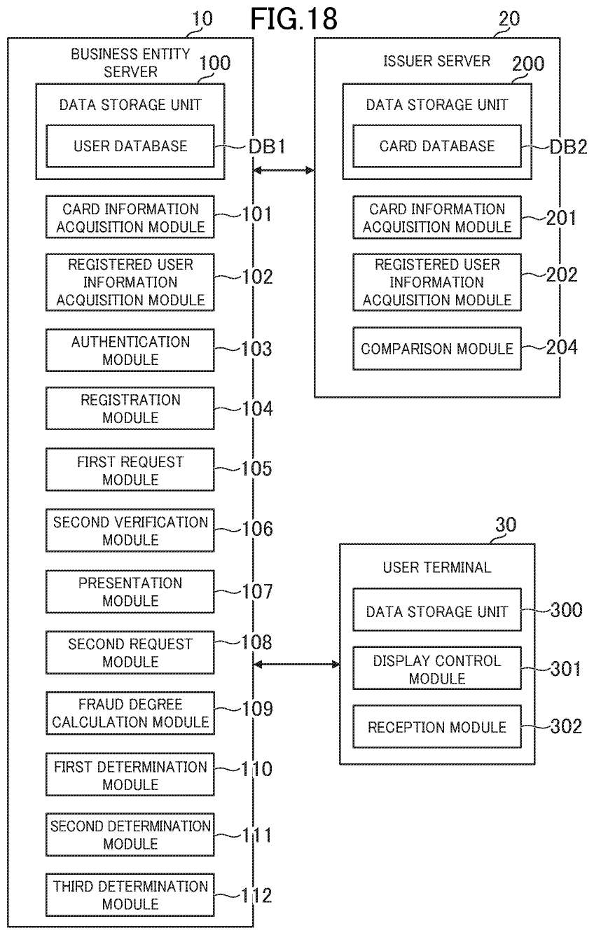

FIG. 18 is a functional block diagram in modification examples of the present disclosure. As illustrated in FIG. 18, in the modification examples described below, in addition to the functions described in the embodiments, a first request module 105, a second verification module 106, a presentation module 107, a second request module 108, a fraud degree calculation module 109, a first determination module 110, a second determination module 111, and a third determination module 112 are implemented. The functions are each implemented mainly by the control unit 11. FIG. 18 is an illustration of a case in which each of the functions is added to the functional blocks in the first embodiment and the third embodiment, but each of the functions may be added to the functional blocks in the second embodiment or the fourth embodiment.

(1) For example, in the second embodiment, when the telephone number managed by the business entity server 10 and the telephone number managed by the issuer server 20 do not match, the user may be requested to input the telephone number. In addition, in this case, the authentication may be executed on the assumption that the telephone number managed by the issuer server 20 is a correct telephone number.

The card registration system S according to Modification Example (1) of the present disclosure includes the first request module 105 and the second verification module 106. When the first verification module 203 does not determine that the match is achieved, the first request module 105 requests the user terminal 30 for the input of the telephone number. The input of the telephone number is requested by displaying a predetermined screen. In Modification Example (1), it is assumed to request the input of all the digits of the telephone number on this screen without any particular hint given.

The second verification module 106 determines whether or not the telephone number input from the user terminal 30 and the telephone number managed by the issuer server 20 match. It is assumed that the second verification module 106 has acquired the telephone number managed by the issuer server 20 in advance. When the second verification module 106 is implemented by the issuer server 20, the business entity server 10 may transfer, to the issuer server 20, the telephone number input by the user.

When the first verification module 203 does not determine that the match is achieved and the second verification module 106 determines that the match is achieved, the authentication module 103 performs the message transmission or the telephone calling to the telephone number managed by the issuer server 20. That is, even when the first verification module 203 does not determine that the match is achieved, the authentication module 103 performs the message transmission or the telephone calling to the telephone number managed by the issuer server 20 as long as the second verification module 106 determines that the match is achieved. The subsequent flow of the authentication is as described in the second embodiment.

According to Modification Example (1), when the telephone number managed by the business entity server 10 and the telephone number managed by the issuer server 20 do not match, the user is requested to input the telephone number, and when the telephone number input by the user and the telephone number managed by the issuer server 20 match, the authentication using the SMS or the telephone is executed, to thereby be able to effectively enhance the security by requesting the input of information that cannot be known by a malicious third party.

(2) Further, for example, when the input of the telephone number is requested as in Modification Example (1), a numerical value being a part of the telephone number may be presented as a hint. The card registration system S according to Modification Example (2) of the present disclosure includes the presentation module 107. The presentation module 107 presents a part of the telephone number managed by the issuer server 20 to the user terminal 30. The presentation may be a visual presentation by an image or an auditory presentation by a voice. A portion to be presented to the user may be defined in advance, or may be randomly determined. For example, a fixed part, for example, the last digit of the telephone number, may be presented, or a digit selected based on a random number may be presented.

The second verification module 106 determines whether or not the telephone number input from the user terminal 30 after a part of the telephone number is presented by the presentation module 107 and the telephone number managed by the issuer server 20 match. That is, the determination processing is executed based on the telephone number input by the user with a part of the telephone number being presented. The determination processing itself is as described in Modification Example (1).

According to Modification Example (2), even when a valid user forgets the telephone number registered in the issuer server 20, it becomes easier for the user to recall the telephone number by being requested to input the telephone number with a part of the telephone number being presented, and hence it is possible to improve the convenience of the valid user. A malicious third party does not know the telephone number from the beginning, and hence it is impossible for the malicious third party to commit a fraud even when only a part of the telephone number is presented, to thereby be able to ensure the security.

(3) Further, for example, in the third embodiment and the fourth embodiment, the part of the address to be input by the user may be randomly selected instead of being set as the fixed portion. The card registration system S according to Modification Example (3) of the present disclosure includes the second request module 108. The second requesting module 108 requests the user terminal 30 for the input of a portion randomly selected from the personal information. For example, the second request module 108 randomly selects a part of personal information based on a random number. The second request module 108 may select a plurality of portions of the personal information.

The authentication module 103 executes the authentication based on the portion registered as the registered user information and the portion input from the user terminal 30 as the input information. It is assumed that information indicating which portion has been selected by the second request module 108 is stored in the data storage unit 100. When those portions match, the authentication is successful. When those portions do not match, the authentication fails.

According to Modification Example (3), the portion of the personal information prompted to be input by the user is randomly determined, to thereby request the user to input the portion that cannot be predicted by a malicious third party. Accordingly, it is possible to effectively enhance the security.

(4) Further, for example, in the third embodiment and the fourth embodiment, some users have a peculiarity in input format, such as whether or not to input the address through use of kanji characters including “ [symbol] (chöome)” and “ [symbol] (ban)” or whether or not to use “-” for hyphenation. Such a peculiarity is reflected in the address stored in the card database DB2 as the registered user information, and hence it may be determined whether or not the address input from the user terminal 30 reflects the peculiarity specific to the user.

The authentication module 103 executes the authentication based on an input format corresponding to the personal information input from the user terminal 30 as the user number and an input format corresponding to the personal information registered as the registered user information. The input format is not limited to such kanji characters and symbols as described above. Examples of the input format to be determined may include whether or not to insert a hyphen in the telephone number, whether or not to input a place name formed of kanji characters in hiragana characters, and whether to input the birth date in the Western calendar or the Japanese calendar. When those input formats match, the authentication is successful. When those input formats do not match, the authentication fails. It may be determined whether or not the input formats match based on whether or not character strings thereof match.

According to Modification Example (4), it is determined whether or not the match with the input format of personal information used by the user is achieved, and hence it is possible to effectively enhance the security through use of the input format that cannot be predicted by a malicious third party.

(5) For example, when a fraud degree of the user can be predicted in advance, the authentication may be changed in strength depending on the fraud degree. The card registration system S according to Modification Example (5) of the present disclosure includes the fraud degree calculation module 109 and the first determination module 110. The fraud degree calculation module 109 calculates the fraud degree of a user based on an action of the user. The fraud degree is information indicating the degree of a fraud or information indicating the level of suspicion of being a fraud. In Modification Example (5), a case in which the fraud degree is expressed by a score is described, but the fraud degree may be expressed by another index. The fraud degree may be expressed by characters, for example, “S rank,” “A rank,” and “B rank.”

For example, the fraud degree calculation module 109 calculates the fraud degree through use of a learning model. The learning model is a model using machine learning (artificial intelligence). As the machine learning itself, it is possible to use various known methods, and it is possible to use a method, for example, a neural network or deep learning. In the learning model, a relationship between an action that can be performed by the user and a determined result of whether or not the action is a fraud has been learned. As the learning model, a model of unsupervised machine learning may be used.

The action is information indicating how the user has used a service. The action can also be said to be details of use of the service or a behavior at a time of use of the service. For example, an IP address of the user terminal 30, a URL accessed by the user terminal 30, a location of the user terminal 30, and an access date/time each correspond to the action of the user. In addition, for example, information on a frequency at which the user has used the service or an amount of money that has been used by the user also corresponds to the action of the user.

It is assumed that data indicating the action of the user is stored in the data storage unit 100. This data is updated each time the user uses the service. The fraud degree calculation module 109 quantifies the action performed until the user displays the input screen G1, and inputs the action to the learning model. The learning model calculates a feature amount of the input action, and outputs the fraud degree corresponding to the feature amount. The fraud degree calculation module 109 acquires the fraud degree output from the learning model.

For example, the fraud degree calculation module 109 calculates the fraud degree so that the fraud degree becomes higher as the IP address varies more widely. Further, for example, the fraud degree calculation module 109 calculates the fraud degree so that the fraud degree becomes higher as the URL accessed by the user varies more widely. Further, for example, the fraud degree calculation module 109 calculates the fraud degree so that the fraud degree becomes higher as the access location is farther apart from the center of the use or the access location varies more widely.

Further, for example, the fraud degree calculation module 109 calculates the fraud degree so that the fraud degree becomes higher as the access date/time is farther apart from an average access date/time or the access date/time varies more widely. Further, for example, the fraud degree calculation module 109 calculates the fraud degree so that the fraud degree becomes higher as the access frequency is farther apart from an average access frequency or the access frequency varies more widely.

The fraud degree is only required to be calculated based on a predetermined method, and is not limited to the example using the learning model. For example, the fraud degree calculation module 109 may calculate the fraud degree of the user through use of not the learning model but a rule that defines a relationship between the action of the user and the fraud degree. In this case, the fraud degree calculation module 109 determines whether or not the action of the user matches the rule. When the action matches the rule, the fraud degree associated with the matched rule is obtained. In another case, for example, the fraud degree calculation module 109 may calculate the fraud degree by quantifying the action of the user and substituting the resultant into a predetermined calculation formula.

The first determination module 110 determines the portion of the personal information to be used for the authentication based on the fraud degree. For example, the first determination module 110 increases the amount of the portion to be used for the authentication as the fraud degree becomes higher. The amount may be the number of input forms or the number of characters to be input in one input form. In addition, for example, the first determination module 110 reduces the amount of the portion to be used for the authentication as the fraud degree becomes lower.

The authentication module 103 executes the authentication based on the portion registered as the registered user information and the portion input from the user terminal 30 as the input information. In the same manner as in the other modification examples, it is assumed that information indicating which portion of the personal information is to be input is stored in the data storage unit 100. When those portions match, the authentication is successful. When those portions do not match, the authentication fails.

According to Modification Example (5), the portion to be input by the user is determined based on the fraud degree of the user, to thereby be able to ensure the security corresponding to the fraud degree of the user. For example, when the fraud degree of the user is high, the amount to be input can be increased to execute highly accurate authentication, and when the fraud degree of the user is low, the amount to be input can be reduced to complete the authentication quickly. As a result, it is possible to improve the convenience of the user while enhancing the security. It is also possible to reduce the processing loads on the entire system by dynamically adjusting the authentication depending on the fraud degree of the user.

(6) Further, for example, a type of personal information to be input may be changed depending on the fraud degree of the user. The card registration system S according to Modification Example (6) of the present disclosure includes the fraud calculation module 109, which is described in Modification Example (5), and the second determination module 111. The second determination module 111 determines the type to be used for the authentication from a plurality of types of the registered user information based on the fraud degree. The type of registered user information refers to an address, a telephone number, a birth date, or another piece of personal information.

For example, the second determination module 111 determines the registered user information to be used for the authentication so that the amount of registered user information to be used for the authentication becomes larger as the fraud degree becomes higher. Further, for example, the second determination module 111 determines the registered user information to be used for the authentication so that the amount of registered user information to be used for the authentication becomes smaller as the fraud degree becomes lower. Further, for example, the second determination module 111 determines that a first piece of registered user information having a relatively large information amount is to be used when the fraud degree is equal to or higher than a threshold value, and determines that a second piece of registered user information having a relatively small information amount is to be used when the fraud degree is lower than the threshold value.

The authentication module 103 executes the authentication based on the registered user information of the type determined by the second determination module 111 and the input information of the determined type input from the user terminal 30. It is assumed that information indicating which type of registered user information is to be input is stored in the data storage unit 100. When those pieces of information match, the authentication is successful. When those pieces of information do not match, the authentication fails.

According to Modification Example (6), the type of personal information prompted to be input by the user is determined based on the fraud degree of the user, to thereby be able to ensure the security corresponding to the fraud degree of the user. For example, when the fraud degree of the user is high, a larger amount of personal information can be input to execute highly accurate authentication, and when the fraud degree of the user is low, the authentication can be completed more quickly. As a result, it is possible to improve the convenience of the user while enhancing the security. It is also possible to reduce the processing loads on the entire system by dynamically adjusting the authentication depending on the fraud degree of the user.

(7) Further, for example, the same processing as that in the second embodiment may be applied to the third embodiment and the fourth embodiment. In Modification Example (7) of the present disclosure, each of the business entity server 10 and the issuer server 20 manages the registered user information. In addition, the card registration system S according to Modification Example (7) includes the comparison module 204. The comparison module 204 compares the registered user information managed by the business entity server 10 and the registered user information managed by the issuer server 20 to each other.

The processing of the comparison module 204 is roughly as described in the second embodiment, but is different from the second embodiment in that the processing of the comparison module 204 is not comparison between the telephone numbers for use in transmitting the SMS through use of the telephone number, but comparison between pieces of personal information for use in prompting the user to input the personal information. The comparison module 204 compares the personal information registered in the business entity server 10 and the personal information registered in the issuer server 20 to each other. As described above, the determining of whether or not those pieces of information match means the comparison.

The authentication module 103 executes the authentication further based on the comparison result obtained by the comparison module 204. The authentication module 103 also assumes, as a condition for the successful authentication, that the comparison module 204 determines that the match is achieved. Accordingly, even when the user inputs some personal information, the authentication is not successful unless the comparison module 204 determines that the match is achieved.

According to Modification Example (7), the authentication is executed through use of a comparison result between the registered user information managed by the business entity server 10 and the registered user information managed by the issuer server 20. When a fraud is suspected, for example, when the two pieces of personal information do not match, the authentication itself is not executed, to thereby be able to reliably prevent unauthorized registration of the card and effectively enhance the security. For example, even when a malicious third party registers the use of the app, the authentication cannot be successful unless the personal information of a valid user has been registered in the business entity server 10, and hence the security is enhanced.

(8) Further, for example, the type of the personal information to be used for the authentication may be determined depending on the type of the card to be registered. The card registration system S according to Modification Example (8) of the present disclosure includes the third determination module 112. The third determination module 112 determines, from the plurality of the types of the registered information, the type to be used for the authentication based on the type of the card. For example, when the type of the card possessed by the user is a first type, the third determination module 112 determines the registered user information that is not used for a second type. It is assumed that a relationship between the type and registered user information is defined in advance by, for example, data having a table format. The third determination module 112 determines, as the registered user information to be used for the authentication, the registered user information associated with the type of the card possessed by the user. The third determination module 112 transmits the information for identifying the registered user information to be used for the authentication.

The authentication module 103 executes the authentication based on the registered user information of the type determined by the third determination module 112 and the input information of the determined type input from the user terminal 30. It is assumed that information indicating which type of registered user information is to be input is stored in the data storage unit 100. When those pieces of information match, the authentication is successful. When those pieces of information do not match, the authentication fails.

According to Modification Example (8), the type of the personal information to be used for the authentication is determined based on the type of the card possessed by the user, to thereby be able to ensure the security corresponding to the type of the card. For example, the authentication can be executed through use of the personal information reliably registered in the card possessed by the user. Further, for example, when a fraud frequently occurs with cards of the same type as that of the card possessed by the user, it is possible to enhance the security through use of a larger amount of personal information for the authentication in order to further enhance the security.

(9) Further, for example, the case in which the card registration system S is applied to the transportation-related service has been described, but the card registration system S can also be applied to services including an electronic payment service, an electronic commerce service, an electronic ticket service, a financial service, a communication service, and a social media service. In Modification Example (9) of the present disclosure, a case in which the card registration system S is applied to the electronic payment service is described.

In Modification Example (9), a credit card is described as an example of the card. The card is not limited to the credit card, and may be any card that can be used for the electronic payment service. For example, the card may be a cash card, a debit card, a loyalty card, an electronic money card, or the card for another electronic value.

The business entity in Modification Example (9) is a company that provides an electronic payment service. The issuer is a company that issues a credit card. Accordingly, in Modification Example (9), the business entity and the issuer are different. The business entity and the issuer cooperate with each other, and any data can be transmitted between the business entity server 10 and the issuer server 20. The business entity and the issuer may companies belonging to the same group.

The card database DB2 of the issuer server 20 stores the card information of an issued credit card. For example, the card information includes a credit card number, an expiration date, a full name, and a security code. Each time the issuer issues a credit card, the issuer stores the personal information input at the time of the issuance of the credit card in the card database DB2 as the registered user information together with the card information.

The user database DB1 of the business entity server 10 stores the card information of the credit card registered in the app. The app in Modification Example (9) is an electronic payment app. The electronic payment app enables electronic payment to be performed by various methods. For example, a user selects a credit card to be used for payment, and causes a bar code or a two-dimensional code to be displayed on the user terminal 30 and to be read by a reader at a shop, to thereby execute the payment using the credit card. In another case, for example, when the photographing unit 36 of the user terminal 30 reads a bar code or a two-dimensional code provided by the shop, payment using a credit card selected by a user is executed. It suffices that the electronic payment app can execute payment using a registered credit card, and the payment method itself is not limited to those examples. For example, the payment using the registered credit card may be executed without particularly using a code.

When the same flow as that of the first embodiment is taken as an example, the user activates the electronic payment app installed on the user terminal 30, and inputs the credit card number and the expiration date on the input screen G1. When the business entity server 10 receives the credit card number and the expiration date, the business entity server 10 transfers the credit card number and the expiration date to the issuer server 20, and the issuer server 20 refers to the card database DB2 to acquire the telephone number associated with the credit card number and the expiration date that have been received.

The business entity server 10 transmits an SMS including a one-time password to the user terminal 30. The user terminal 30 transmits, to the business entity server 10, the one-time password input by the user. The business entity server 10 confirms whether or not the one-time password is valid, and when the authentication is successful, registers the credit card number and other information in the user database DB1. In Modification Example (9) as well, the registration processing can be performed by the same flow as in the second embodiment to the fourth embodiment.

According to Modification Example (9), the security exhibited when a credit card is registered for an electronic payment service is enhanced.

(10) Further, for example, the modification examples described above may be combined.

Further, for example, the card may be an insurance card, a driver's license, a membership card, a student ID card, or another card. The card to be utilized for the possession authentication may be an electronic card (virtual card) instead of a physical card. Further, for example, when the authentication fails, the determination may be manually performed by an administrator. Further, for example, when the authentication corresponding to a certain card number fails a predetermined number of times, the card number may be restricted so that no further authentication is executed thereon. In this case, the card number may be restricted so that the card number is not registered in the app unless permission is granted by the administrator.

Further, for example, the case in which the main functions are shared by the business entity server 10 and the issuer server 20 has been described, but each function may be implemented by one computer. Further, for example, the function described as being implemented by the business entity server 10 may be implemented by the issuer server 20. In contrast, the function described as being implemented by the issuer server 20 may be implemented by the business entity server 10. Further, for example, each function may be shared by three or more computers.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A card registration system, comprising at least one processor configured to:
acquire, when a registration request for a card is received from a user terminal, card information that enables identification of the card;
acquire registered user information on a user who possesses the card, which has been registered in a server in advance in association with the card information;
execute authentication based on the registered user information and input information input from the user terminal; and
register the card based on an execution result of the authentication.

2. The card registration system according to claim 1,
wherein the registered user information comprises a telephone number, and
wherein the at least one processor is configured to:
perform one of message transmission and telephone calling to the telephone number, to thereby notify the user of authentication information; and
execute the authentication based on authentication information input from the user terminal as the input information and the notified authentication information.

3. The card registration system according to claim 2, further comprising:
a business entity server corresponding to a business entity that provides a service using the card; and
an issuer server corresponding to an issuer that has issued the card,
wherein the business entity server and the issuer server are each configured to manage the telephone number, and
wherein the at least one processor is configured to:
determine whether the telephone number managed by the business entity server and the telephone number managed by the issuer server match; and
perform one of the message transmission and the telephone calling when it is determined that the telephone number managed by the business entity server and the telephone number managed by the issuer server match.

4. The card registration system according to claim 3, wherein the at least one processor is configured to:
request the user terminal for input of the telephone number when it is not determined that the telephone number managed by the business entity server and the telephone number managed by the issuer server match;
determine whether a telephone number input from the user terminal and the telephone number managed by the issuer server match; and
perform one of the message transmission and the telephone calling to the telephone number managed by the issuer server when it is not determined that the telephone number managed by the business entity server and the telephone number managed by the issuer server match and it is determined that the telephone number input from the user terminal and the telephone number managed by the issuer server match.

5. The card registration system according to claim 4, wherein the at least one processor is configured to:
present, to the user terminal, a part of the telephone number managed by the issuer server; and
determine whether a telephone number input from the user terminal after the part of the telephone number is presented and the telephone number managed by the issuer server match.

6. The card registration system according to claim 3, wherein the business entity server is configured to acquire, from the issuer server, a result of the determination of whether the telephone number managed by the business entity server and the telephone number managed by the issuer server match.

7. The card registration system according to claim 2, further comprising:
a business entity server corresponding to a business entity that provides a service using the card; and
an issuer server corresponding to an issuer that has issued the card,
wherein the issuer server is configured to manage the telephone number as the registered user information, and
wherein the business entity server is configured to:
acquire the telephone number from the issuer server as the registered user information; and
perform one of the message transmission and the telephone calling to the telephone number.

8. The card registration system according to claim 1,
wherein the registered user information comprises personal information, and
wherein the at least one processor is configured to execute the authentication based on all or a part of the personal information registered as the registered user information and all or a part of the personal information input from the user terminal as the input information.

9. The card registration system according to claim 8, wherein the at least one processor is configured to:
request the user terminal for input of a portion randomly selected from the personal information; and
execute the authentication based on the portion registered as the registered user information and the portion input from the user terminal as the input information.

10. The card registration system according to claim 8, wherein the at least one processor is configured to execute the authentication based on an input format corresponding to the personal information input from the user terminal as the input information and an input format corresponding to the personal information registered as the registered user information.

11. The card registration system according to claim 8, wherein the at least one processor is configured to:
calculate a fraud degree of the user based on an action of the user;
determine a portion of the personal information to be used for the authentication based on the fraud degree; and
execute the authentication based on the portion registered as the registered user information and the portion input from the user terminal as the input information.

12. The card registration system according to claim 8, further comprising:
a business entity server corresponding to a business entity that provides a service using the card; and
an issuer server corresponding to an issuer that has issued the card,
wherein the issuer server is configured to manage the personal information as the registered user information, and
wherein the business entity server is configured to acquire the personal information from the issuer server as the registered user information.

13. The card registration system according to claim 8, further comprising:
a business entity server corresponding to a business entity that provides a service using the card; and
an issuer server corresponding to an issuer that has issued the card,
wherein the issuer server is configured to compare the all or a part of the personal information input from the user terminal as the input information and the all or a part of the personal information registered as the registered user information to each other, and
wherein the business entity server is configured to acquire a result of the comparison from the issuer server, and execute the authentication.

14. The card registration system according to claim 1, wherein the at least one processor is configured to:
calculate a fraud degree of the user based on an action of the user;
determine a type to be used for the authentication from a plurality of types of the registered user information based on the fraud degree; and
execute the authentication based on the registered user information of the determined type and the input information of the determined type input from the user terminal.

15. The card registration system according to claim 1, further comprising:
a business entity server corresponding to a business entity that provides a service using the card; and
an issuer server corresponding to an issuer that has issued the card,
wherein the business entity server and the issuer server are each configured to manage the registered user information, and
wherein the at least one processor is configured to:
compare the registered user information managed by the business entity server and the registered user information managed by the issuer server to each other; and
execute the authentication further based on a result of the comparison between the registered user information managed by the business entity server and the registered user information managed by the issuer server.

16. The card registration system according to claim 1, wherein the at least one processor is configured to:
determine a type to be used for the authentication from a plurality of types of the registered user information based on a type of the card; and
execute the authentication based on the registered user information of the determined type and the input information of the determined type input from the user terminal.

17. A card registration method, comprising:
acquiring, when a registration request for a card is received from a user terminal, card information that enables identification of the card;
acquiring registered user information on a user who possesses the card, which has been registered in a server in advance in association with the card information;
executing authentication based on the registered user information and input information input from the user terminal; and
registering the card based on an execution result of the authentication.

18. A non-transitory information storage medium having stored thereon a program for causing a computer to:
acquire, when a registration request for a card is received from a user terminal, card information that enables identification of the card;
acquire registered user information on a user who possesses the card, which has been registered in a server in advance in association with the card information;
execute authentication based on the registered user information and input information input from the user terminal; and
register the card based on an execution result of the authentication.
